(19) United States
(12) Patent Application Publication
(10) Pub. No.: US 2019/0045843 A1
(43) Pub. Date: Feb. 14, 2019

(54) BATTERY COMPARTMENT AND ELECTRONIC CIGARETTE USING SAME

(71) Applicant: SHENZHEN IVPS TECHNOLOGY CO., LTD., Shenzhen (CN)

(72) Inventor: Wen CHEN, Shenzhen (CN)

(73) Assignee: SHENZHEN IVPS TECHNOLOGY CO., LTD., Shenzhen (CN)

(21) Appl. No.: 15/871,946

(22) Filed: Jan. 15, 2018

(30) Foreign Application Priority Data
Nov. 29, 2016 (CN) 201621296417.8

(51) Int. Cl. A24F 47/00; H01R 13/24; H02J 7/00; H01M 2/10; A24F 15/18

(52) U.S. Cl. CPC A24F 47/008; H01R 13/2421; A24F 15/18; H01M 2/1055; H02J 7/0044

(57) ABSTRACT

The present disclosure relates to a battery compartment and an electronic cigarette using the same. The battery compartment comprises a housing, a positive elastic plate, a negative elastic plate and a PCB BOARD. The housing comprises an accommodating groove to which the PCB BOARD is connected. The positive elastic plate and the negative elastic plate are directly fixed on two ends of the PCB BOARD respectively along an extension direction of a groove body of the accommodating groove, and connected with the PCB BOARD electrically. In the battery compartment, by fixing the positive elastic plate and negative elastic plate on the PCB BOARD directly, current is led by the wiring layout on the PCB BOARD, so as to avoid a direct contact of conducting wire with the positive and negative plates. At the same time, the wiring layout on the PCB BOARD could bear a large current load.

### CROSS REFERENCE TO RELATED APPLICATIONS

The present application claims priority to Chinese Patent Application CN 201621296417.8 filed on Nov. 29, 2016.

### TECHNICAL FIELD

The present disclosure relates to technical filed of electronic elements, and particularly to a battery compartment and an electronic cigarette using the same battery compartment.

### BACKGROUND

At present in the battery compartment of the present electronic products, its positive and negative pole pieces which connect with positive and negative poles of the battery are all directly fixed on inner surface of the housing of the battery compartment firstly. Then conducting wires are weld on the positive and negative pole pieces respectively and connected to a main control PCB. This kind of connection structure of the battery compartment is not compact, and it requires a high quality of installation process. Once unsoldering, sealing off or damage of insulation layer of conducting wires, it affects the using of the electronic products, and even causes explosion because of the short circuit of the battery. The reliability and security of the electronic products are seriously influenced.

### SUMMARY

The present disclosure mainly aims to provide a battery compartment and an electronic cigarette using the same, so as to improve the reliability and security of the battery compartment in using.

In order to achieve the above aim, the present disclosure provides a battery compartment. The battery compartment comprises a housing, a positive elastic plate, a negative elastic plate and a PCB BOARD. The housing comprises an accommodating groove, and the PCB BOARD is connected with a bottom of the accommodating groove. The positive elastic plate and the negative elastic plate are directly fixed on two ends of the PCB BOARD respectively along an extension direction of a groove body of the accommodating groove, and electrically connected with the PCB BOARD.

Preferably, the battery compartment further comprises a spring connected with the negative elastic plate.

Preferably, the spring and the negative elastic plate are buckle fixing.

Preferably, the PCB BOARD is further set with a positive identifier and a negative identifier.

Preferably, both the positive elastic plate and negative elastic plate are made of phosphor bronze material.

Preferably, both the positive elastic plate and the negative elastic plate are fixed on the PCB BOARD through welding.

Preferably, both the positive elastic plate and the negative elastic plate are detachably fixed on the PCB BOARD.

Preferably, the housing further comprises anti-slip protrusions, and the anti-slip protrusions are set on a side of the accommodating groove.

The present disclosure further provides an electronic cigarette, and it comprises the above descript battery compartment.

In the present disclosure, the battery compartment comprises a housing, a positive elastic plate, a negative elastic plate and a PCB BOARD. The housing comprises an accommodating groove. The PCB BOARD is connected with a bottom of the accommodating groove, and the positive elastic plate and the negative elastic plate are fixed to two ends of the PCB BOARD respectively along a groove body direction of the accommodating groove. By fixing the positive elastic plate and the negative elastic plate on the PCB BOARD directly, current is led by the wiring layout on the PCB BOARD, so as to avoid a direct contact of conducting wire with the positive and negative pole plates. At the same time, the wiring layout on the PCB BOARD could bear a large current load. Reliability and security of the battery compartment are improved a lot in using.

### BRIEF DESCRIPTION OF THE DRAWINGS

For a better understanding of the embodiments of the present disclosure or the technical scheme in the prior art, accompanying drawings needed in the description of the embodiments or the prior art are simply illustrated below. Obviously, the accompanying drawings described below are some embodiments of the present disclosure. For the ordinary skill in the field, other accompanying drawings may be obtained according to the structure shown in these accompanying drawings without creative work.

FIG. 1 is an exploded view of the battery compartment of the present disclosure.

### DESCRIPTION OF REFERENCE NUMBERS

| Reference number | Part |
|---|---|
| 10 | housing |
| 11 | accommodating |
| | groove |
| 20 | positive elastic plate |
| 30 | negative elastic plate |
| 40 | PCB BOARD |
| 50 | spring |
| 60 | anti-slip protrusion |

The implementation of aims, the function features and the advantages of the present disclosure are described below in further detail in conjunction with embodiments with reference to the drawings.

### DETAILED DESCRIPTION

A clear and complete description as below is provided for the technical scheme in the embodiments of the present disclosure in conjunction with the drawings in the embodiments of the present disclosure. Obviously, the embodiments described hereinafter are simply part embodiments of the present disclosure, but all the embodiments. All other embodiments obtained by the ordinary skill in the art based on the embodiments in the present disclosure without creative work are intended to be included in the scope of protection of the present disclosure.

It should be noted that all directional indications (such as top, bottom, left, right, front, behind . . . ) in the embodiments of the present disclosure are merely to illustrate a relative position relation, a relative motion condition, etc. between each part in a certain state (for example, the state shown in the drawings). If the state changes, the directional indication changes accordingly.

In addition, if terms “first”, “second”, etc. appear in the present disclosure, they are merely for the purpose of description, but cannot be understood as the indication or implication of relative importance or as the implicit indication of the number of the designated technical features; therefore, features defined by “first” and “second” may specifically or implicitly include at least one such feature. In the description of the present disclosure, unless there is a definite and specific restriction, “many” means at least two, such as two or three.

In the present disclosure, unless otherwise specifically stated and defined, terms “connected”, “fixed”, etc. should be interpreted expansively. For example, “fixed” may be fixed connection, also may be detachable connection, or integration; may be mechanical connection, also may be electrical connection; may be direct connection, also may be indirect connection through an intermediate, and may be internal communication between two elements or interaction of two elements, unless otherwise specifically defined. The ordinary skill in this field can understand the specific implication of the above terms in the present disclosure according to specific conditions.

In addition, technical schemes of each embodiment of the present disclosure may be combined mutually; however, this must be carried out on the basis that the ordinary skill in this field can implement the combination. When the combination of technical schemes has a conflict or cannot be implemented, it should be considered that such combination of technical schemes does not exist and is not in the scope of protection claimed by the present disclosure.

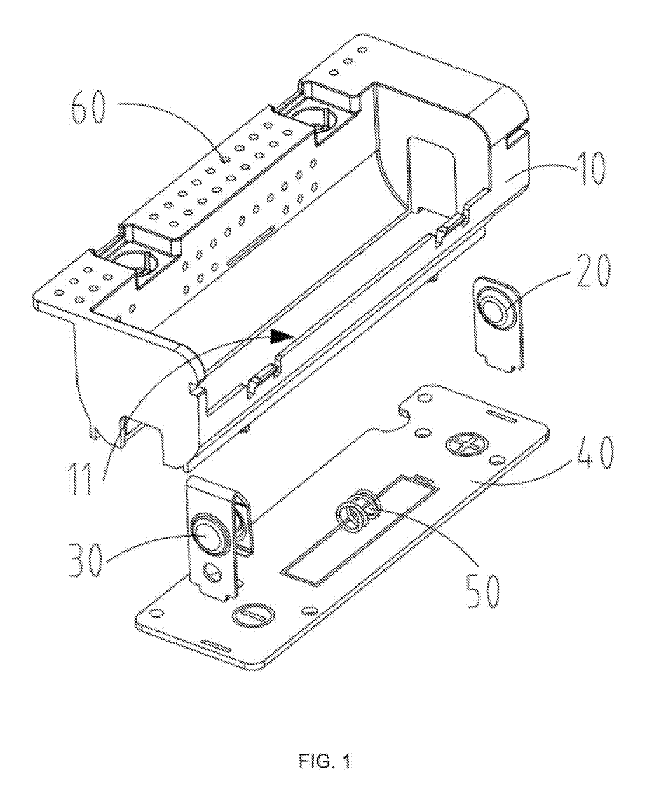

Referring to FIG. 1, the present disclosure provides a battery compartment. The battery compartment comprises a housing 10, a positive elastic plate 20, a negative elastic plate 30 and a PCB BOARD 40. The housing 10 comprises an accommodating groove 11. The PCB BOARD 40 is connected with a bottom of the accommodating groove 11. The positive elastic plate 20 and the negative elastic plate 30 are fixed on two ends of the PCB BOARD 40 respectively along a groove body direction of the accommodating groove 11.

In the present disclosure the battery compartment comprises the housing 10, the positive elastic plate 20, the negative elastic plate 30 and the PCB BOARD 40. The housing 10 comprises an accommodating groove 11. The PCB BOARD 40 is connected with the bottom of the accommodating groove 11. The positive elastic plate 20 and the negative elastic plate 30 are directly fixed on two ends of the PCB BOARD 40 respectively along an extension direction of the groove body of the accommodating groove 11, and connected with the PCB BOARD 40 electrically. By fixing the positive elastic plate 20 and the negative elastic plate 30 on the PCB BOARD 40 directly, current is led by the wiring layout on the PCB BOARD 40, so as to avoid a direct contact of conducting wire with the positive and negative plates. At the same time, the wiring layout on the PCB BOARD could bear a large current load. Reliability and security of the battery compartment are improved a lot in using.

Preferably, the battery compartment further comprises a spring 50 connected with the negative elastic plate 30, and the spring 50 is located on a side of the negative elastic plate 30 facing the positive elastic plate 20.

As the spring 50 connected with the negative elastic plate 30 is set within the battery compartment, the distance between a battery and the negative elastic plate 30 is adjustable, and so it is easy to install the battery.

Preferably, the spring 50 and negative elastic plate 30 are buckle fixing.

As the spring 50 is fixed with the negative elastic plate 30 through buckle, the installation structure of the battery compartment is simplified, and the manufacturing process is simplified too.

Preferably, the PCB BOARD 40 is further set with a positive identifier and a negative identifier (not illustrated).

The positive identifier and the negative identifier are set on the PCB BOARD 40 to remind users to correctively install the battery according to the identification, so as to humanize the using of the battery compartment.

Preferably, the positive elastic plate 20 and the negative elastic plate 30 both are made of phosphor bronze material.

To ensure the electrical conductivity of the positive and negative electrodes, the positive elastic plate 20 and the negative elastic plate 30 both are made of phosphor bronze material. The phosphor bronze material has improved corrosion resistance, abrasion resistant and better electrical conductivity. Electric elements made of phosphor bronze material have the benefit of lower heat generating and improved fatigue resistance, so as to ensure a better contact between electric assemblies and a steady plug-in and plug-out performance.

Preferably, the positive elastic plate 20 and negative elastic plate 30 both are fixed on the PCB BOARD 40 through welding.

As the positive elastic plate 20 and the negative elastic plate 30 both are fixed on the PCB BOARD 40 through welding, the wiring layout between the positive elastic plate 20, the negative elastic plate 30 and the PCB BOARD 40 has a good electrical conductivity, and the connection has a better steadiness.

Preferably, the positive elastic plate 20 and the negative elastic plate 30 both are detachably fixed on the PCB BOARD 40.

As another embodiment of the present disclosure, the positive elastic plate 20 and the negative elastic plate 30 both are detachably fixed on the PCB BOARD 40. And the installation process is simplified and it is easy to replace components.

Preferably, the housing 10 further comprises anti-slip protrusions 60, and the anti-slip protrusions 60 are set on one side of the accommodating groove 11.

As one side of the accommodating groove 11 are set with anti-slip protrusions 60, damping sense is improved when users holding the products by hands, and so as to the security in using is improved.

The present disclosure further provides an electronic cigarette. The electronic cigarette comprises the above mentioned battery compartment. The detail structure of the battery compartment refers to the above embodiments. As the electronic cigarette adopt the total technical solutions of all above embodiments, it at least has all benefits of the technical solutions of above embodiments. And it will not be repeated here again.

The above are preferred embodiments of the present disclosure merely and are not intended to limit the patent scope of the present disclosure. Any equivalent structures made according to the description and the accompanying drawings of the present disclosure without departing from the idea of the present disclosure, or any equivalent structures applied in other relevant technical fields directly or indirectly are intended to be included in the patent protection scope of the present disclosure.

What is claimed is:

1. A battery compartment, wherein the battery compartment comprises a housing, a positive elastic plate, a negative elastic plate and a PCB BOARD, the housing comprises an accommodating groove, the PCB BOARD is connected with a bottom of the accommodating groove, the positive elastic plate and the negative elastic plate are directly fixed on two ends of the PCB BOARD respectively along an extension direction of a groove body of the accommodating groove, and electrically connected with the PCB BOARD.

2. The battery compartment according to claim 1, wherein the battery compartment further comprises a spring connected with the negative elastic plate, the spring is located at a side of the negative elastic plate facing the positive elastic plate.

3. The battery compartment according to claim 2, wherein the spring and the negative elastic plate are buckle fixing.

4. The battery compartment according to claim 1, wherein the PCB BOARD is further set with a positive identifier and a negative identifier.

5. The battery compartment according to claim 1, wherein both the positive elastic plate and the negative elastic plate are made of phosphor bronze material.

6. The battery compartment according to claim 1, wherein both the positive elastic plate and the negative elastic plate are fixed on the PCB BOARD through welding.

7. The battery compartment according to claim 1, wherein both the positive elastic plate and the negative elastic plate are detachably fixed on the PCB BOARD.

8. The battery compartment according to claim 1, wherein the housing further comprises anti-slip protrusions, the anti-slip protrusions are set on a side of the accommodating groove.

9. An electronic cigarette, wherein the electronic cigarette comprises the battery compartment according to claim 1.
